(19) United States
(12) Patent Application Publication
(10) Pub. No.: US 2002/0129154 A1
(43) Pub. Date: Sep. 12, 2002

(54) Router and control method of audio/video apparatus using the router

(76) Inventors: Sumihiro Okawa, Kanagawa (JP); Masataka Ogawa, Chiba (JP); Yuji Sekiguchi, Tokyo (JP); Toru Takeda, Saitama (JP); Akihito Fukutani, Kanagawa (JP); Yoshiyuki Kunito, Kanagawa (JP)

Correspondence Address: WILLIAM S. FROMMER, Esq., c/o FORMMER LAWRENCE & HAUG LLP, 745 Fifth Avenue, New York, NY, 10151, US

(21) Appl. No.: 10/092,830

(22) Filed: Mar. 7, 2002

(30) Foreign Application Priority Data
Mar. 9, 2001 (JP) P2001-066755

(51) Int. Cl. G06F 15/16

(52) U.S. Cl. 709/230

(57) ABSTRACT

A router emits an infrared ray based on a signal for operating a video recorder to the video recorder at a request made by any one of personal computers connected to the router through a network. In response to the infrared ray based on a signal for operating the video recorder, the video recorder outputs analog signals to the router through cables. The router then converts the analog signals into audio and video digital signals. Subsequently, the router outputs the digital signals to the personal computer making the request by way of the network. Then, the personal computer making the request outputs a sound based on the audio digital signal and displays a picture based on the video digital signal. As a result, the router allows an analog apparatus such as the video recorder to be connected to the network in a simple configuration.

### BACKGROUND OF THE INVENTION

The present invention relates to a router used typically in construction of a computer network at a home and a control method of an audio/video apparatus using the router.

A home router having an IP routing function and employing an ISDN or analog modem has been designed as a product for constructing a computer network at a home.

The home router is provided with Ethernet ports, through which a plurality of personal computers are connected to the home router, so that the personal computers are each capable of making an access to the Internet and communicating with each other by adoption of a TCP/IP. Thus, by implementation of Ethernet wiring, personal computers installed in different rooms of a home are capable of communicating with each other. As a result, it is possible to implement a home network based on personal computers.

By the way, the so-called audio/video apparatus also exist at a home in addition to such personal computers. The audio/video apparatus include a television, a video recorder and an audio apparatus. Since an Ethernet port and the TCP/IP is not implemented in each of the audio/video apparatus, however, they cannot each be connected to the home network cited above.

There has been provided a method of connecting these audio/video apparatus to each other by using a special network. Since the special network is not used in general, however, construction of the special network unavoidably entails a high cost. There are also audio/video apparatus each having a digital interface such as the IEEE 1394. Since these audio/video apparatus are expensive, nevertheless, they can be hardly said to be general apparatuses.

As described above, it is thus extremely difficult to connect the conventional audio/video apparatus to a home network based on personal computers installed at a home. With a low-cost configuration, it is thus impossible to carry out operations such as controlling an audio/video apparatus by using a signal generated by a personal computer connected to the home network and displaying a picture or the like played back by an audio/video apparatus on the screen of a personal computer connected to the home network.

### SUMMARY OF THE INVENTION

It is an object of the present invention addressing the problems described above to provide a router capable of connecting an analog apparatus to a network in a simple configuration and provide a method for controlling an audio/video apparatus used as an analog apparatus through the router.

In order to solve the problems described above, in accordance with a first aspect of the present invention, there is provided a router including: routing means for routing an IP packet; an infrared-ray-emitting unit for emitting an infrared ray to an external apparatus; and control means for controlling the infrared-ray-emitting unit to emit an infrared ray based on a signal for controlling the external apparatus in accordance with data included in an IP packet received by the routing means.

In addition, in accordance with a second aspect of the present invention, there is provided a router including: an infrared-ray-emitting device for controlling an external apparatus; and an analog input port for receiving an analog signal from the external apparatus.

Furthermore, in accordance with a third aspect of the present invention, there is provided a method for controlling an audio/video apparatus by using a router. The method includes the steps of: emitting an infrared ray based on a signal for controlling the audio/video apparatus from the router to the audio/video apparatus in accordance with a request made by a computer connected to the router; driving the router to convert an analog signal supplied by the audio/video apparatus as a result of execution of an operation at the above step to the router into a digital signal; and outputting the digital signal obtained as a result of conversion from the router to the computer.

Taking advantage of the fact that an audio/video apparatus normally has an infrared-ray-receiving unit for receiving an infrared ray generated by a remote controller, the present invention provides a router with, for example, an infrared-ray-emitting unit for emitting an infrared ray to such an infrared-ray-receiving unit, allowing the audio/video apparatus serving as an external apparatus to be controlled by a computer connected to the router through a communication line and the router. In addition, taking advantage of the fact that an external apparatus such as an audio/video apparatus has an analog output port for outputting an ordinary analog signal, the present invention provides a router with, for example, an analog input port and analog-to-digital conversion means, allowing the router to pass on audio and/or video signals generated by the external apparatus to a computer. Thus, in accordance with the present invention, an analog apparatus can be connected to a network in a simple configuration.

### BRIEF DESCRIPTION OF THE DRAWINGS

FIG. 1 is a block diagram showing the configuration of a router implemented by an embodiment of the present invention;

FIG. 2 is a diagram showing an external appearance of the router shown in FIG. 1;

FIG. 3 is a diagram showing a typical configuration of a home network using the router shown in FIGS. 1 and 2;

FIG. 4 is a diagram showing time charts of RTSP (Real Time Streaming Protocol) control between a personal computer and the router implemented by the embodiment; and

FIG. 5 is a diagram showing a squint view of a router implemented by another embodiment of the present invention.

### DETAILED DESCRIPTION OF THE PREFERRED EMBODIMENTS

Preferred embodiments of the present invention are explained by referring to diagrams as follows.

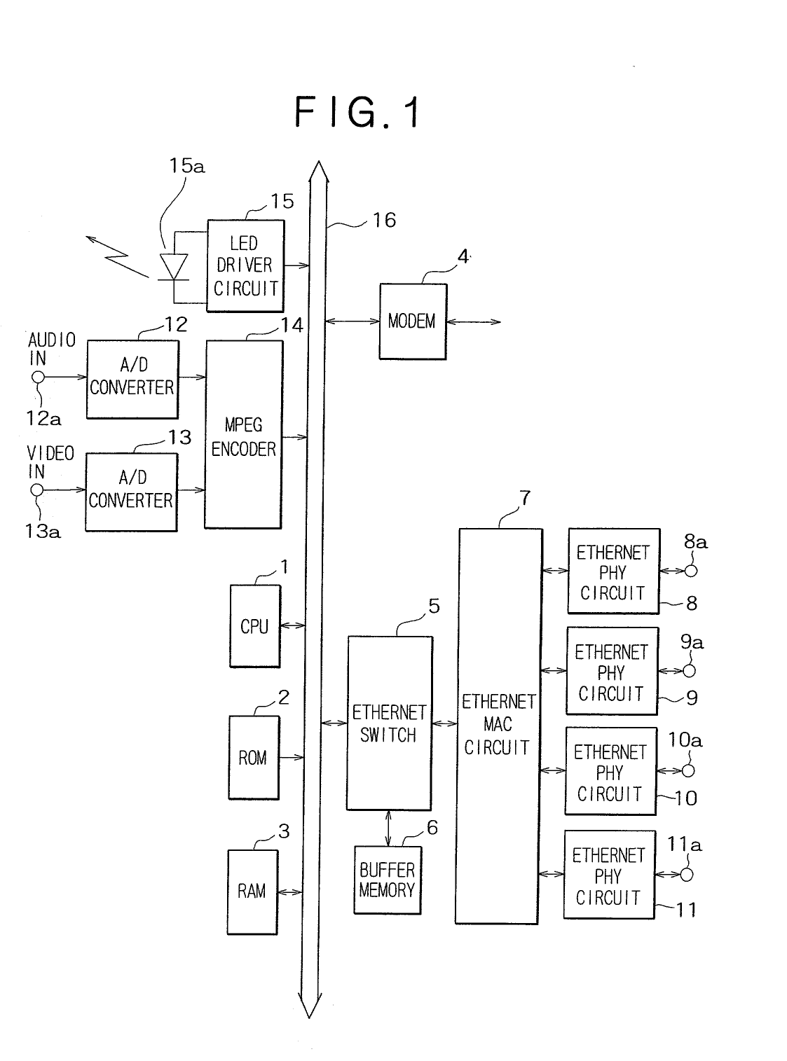

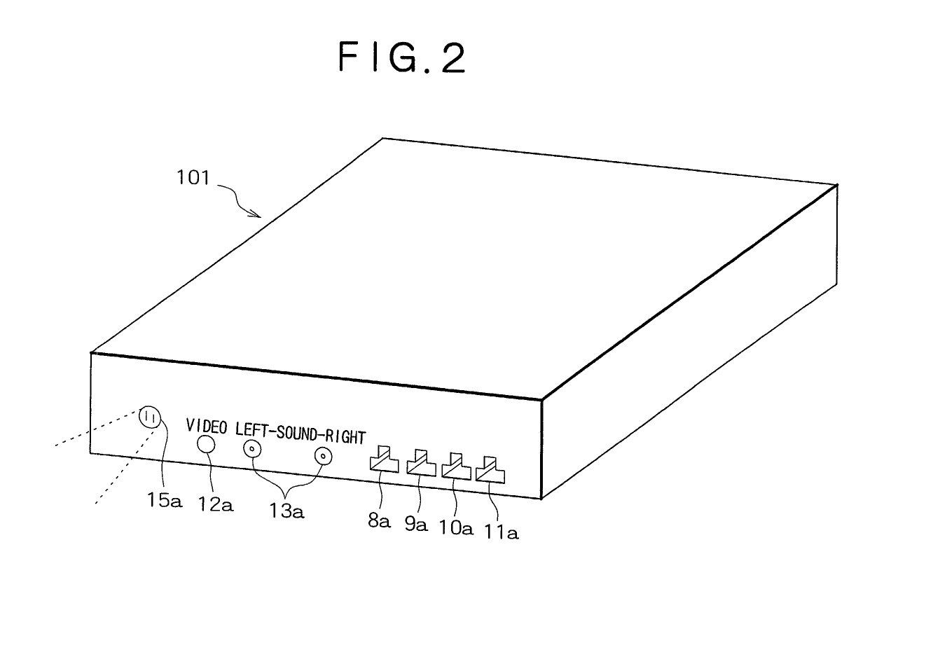

FIG. 1 is a block diagram showing the configuration of a router implemented by an embodiment of the present invention and FIG. 2 is a diagram showing an external appearance of the router.

In FIG. 1, reference numeral 1 denotes a CPU for executing entire control of the router 101 by execution of the TCP/IP and/or a variety of communication protocols. The TCP/IP and/or a variety of communication protocols are written in firmware. Reference numeral 2 denotes a ROM for storing the firmware executed by the CPU 1. Reference numeral 3 denotes a RAM necessary for execution of the firmware by the CPU 1.

Reference numeral 4 denotes a modem for connecting the router 101 to typically a service provider through a telephone line. Reference numeral 5 denotes an Ethernet switch for controlling routes of data packets. Reference numeral 6 denotes a buffer memory for temporarily storing a data packet for switching.

Reference numeral 7 denotes a 4-port Ethernet MAC (Media Access Control) circuit. Reference numerals 8 to 11 each denote an Ethernet PHY (Physical Layer Device) circuit. The Ethernet MAC circuit 7 converts a data packet received from the Ethernet switch 5 into a signal to be output to any of the Ethernet PHY circuits 8 to 11. The Ethernet MAC circuit 7 also converts a signal received from any of the Ethernet PHY circuits 8 to 11 into a data packet to be output to the Ethernet switch 5. The Ethernet PHY circuits 8 to 11 each output and input a signal to and from an Ethernet cable. Thus, the Ethernet switch 5 controls routes of data packets exchanged between the modem 4 and Ethernet ports 8a to 11a of the Ethernet PHY circuits 8 to 11 respectively.

Reference numeral 12 denotes an audio A/D converter for converting an analog audio signal received from a source external to the router 101 through an audio-signal input port 12a into a digital signal. On the other hand, reference numeral 13 denotes a video A/D converter for converting an analog video signal received from a source external to the router 101 through a video-signal input port 13a into a digital signal. Reference numeral 14 denotes an MPEG (Moving Picture Experts Group) encoder for compressing the digital audio and video signals obtained as results of conversions by the audio A/D converter 12 and the video A/D converter 13 respectively.

Reference numeral 15 denotes a LED driver circuit for remotely controlling an audio/video apparatus such as a video recorder or an audio apparatus by using an infrared ray. The LED driver circuit 15 drives an LED 15a to emit an infrared ray in accordance with data received from the CPU 1.

Reference numeral 16 denotes a data bus of the CPU 1. The data bus 16 connects the CPU 1 to the other functional blocks.

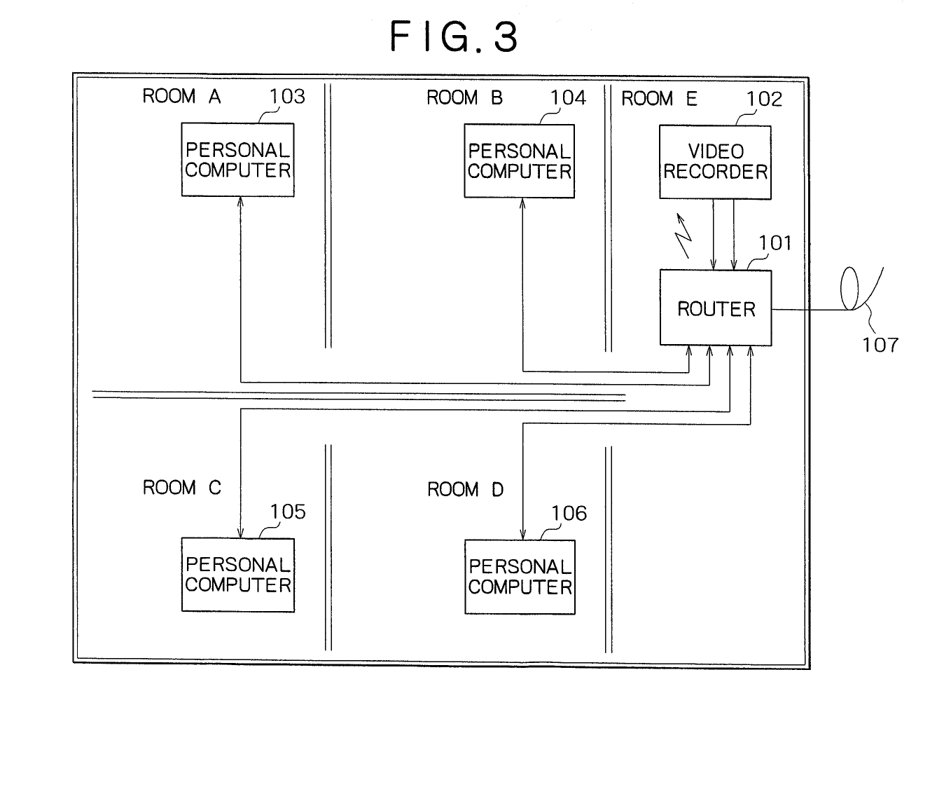

FIG. 3 is a diagram showing a typical configuration of a home network actually using the router 101.

As shown in FIG. 3, the router 101 is connected to a telephone line 107 by the modem 4 shown in FIG. 1. The telephone line 107 is connected to the Internet through a service provider.

In FIG. 3, reference numeral 102 denotes a video recorder. The video recorder 102 is connected to the router 101 through the audio-signal port 12a for inputting an analog audio signal and the video-signal port 13a for inputting an analog video signal. The video recorder 102 is remotely controlled by an infrared ray emitted by the LED 15a driven by the LED driver circuit 15.

Assume that the router 101 and the video recorder 102 are installed in a room E whereas personal computers 103 to 106 are installed in other rooms A, B, C and D respectively. The personal computers 103 to 106 are each connected to the router 101 by an Ethernet cable. Thus, the personal computers 103 to the 106 are capable of communicating with each other through the router 101 and making accesses to the Internet by way of the router 101 and the telephone line 107.

In addition, in the router 101, the audio and video signals, which each have completed an MPEG conversion, are accommodated in IP packets for transmission through the Ethernet cables to the personal computers 103 to 106. In the personal computers 103 to 106, MPEG data received from the video recorder 102 by way of the router 101 and the Ethernet cables is decoded to play back the original audio and video signals.

If a control protocol such as the RTSP (Real Time Streaming Protocol) is implemented in the personal computers 103 to 106 and the router 101, the personal computers 103 to 106 are each capable of transmitting an RTSP control command to the router 101. The CPU 1 employed in the router 101 shown in FIG. 1 is capable of converting the RTSP control command into infrared-ray remote-control data such as an SIRCS (Serial Infrared Remote Control System) command to be output to the video recorder 102 by way of the LED driver circuit 15. Thus, the personal computers 103 to 106 are each capable of remotely controlling the video recorder 102 through the router 101.

The following description explains operations carried out by the personal computers 103 to 106 to remotely control the video recorder 102 through the router 101 and operations to play back audio and video signals generated by the video recorder 102 in the personal computers 103 to 106.

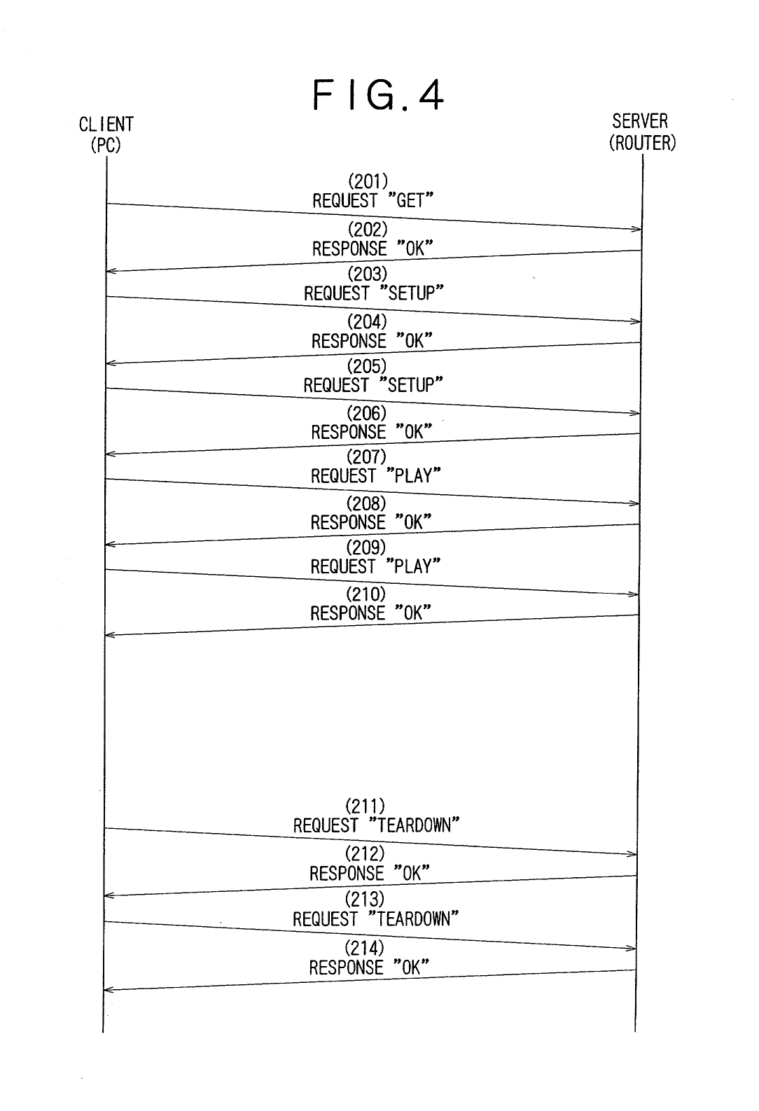

In this case, RTSP control between the personal computers 103 to 106 and the router 101 is executed as shown in FIG. 4.

In the RTSP control shown in FIG. 4, the personal computers 103 to 106 each serve as a client whereas the router 101 serves as a server.

First of all, a specific one of the personal computers 103 to 106 transmits a GET request 201 to the router 101 to make an inquiry about contents of existing data.

In response to the GET request 201, the router 101 transmits an OK status signal 202 and a response indicating that data streams of audio and video signals exist to the specific one of the personal computers 103 to 106.

Next, the specific one of the personal computers 103 to 106 transmits a SETUP request 203 and parameters for establishing a route for the data stream of audio signals to the router 101. In response to the SETUP request 203, the router 101 transmits an OK status signal 204 and returns the parameters for establishing a route for the data streams of audio and video signals.

By the same token, then, a SETUP request 205 is transmitted from the specific personal computer to the router 101 and an OK status response 206 is transmitted from the router 101 to the specific personal computer.

Subsequently, the specific one of the personal computers 103 to 106 transmits a PLAY request 207 for starting a transmission of the data stream of an audio signal to the router 101. In response to the PLAY request 207, the router 101 transmits an OK status signal 208 and parameters relevant to the start of the transmission of the data stream of an audio signal in order to indicate that the transmission to the specific one of the personal computers 103 to 106 will be actually started.

In the same way, the specific one of the personal computers 103 to 106 transmits a PLAY request 209 for starting a transmission of the data stream of a video signal to the router 101 and, in response to the PLAY request 209, the router 101 transmits an OK status signal 210 to the specific one of the personal computers 103 to 106.

After transmitting the OK status signals 208 and 210, the CPU 1 employed in the router 101 converts each of the PLAY requests 207 and 209 each serving as an RTSP control command into infrared-ray remote-control data such as an SIRCS command to be output to the LED driver circuit 15. The data drives the LED driver circuit 15 to transmit an infrared-ray remote-control signal from its LED 15a. The infrared-ray remote-control signal puts the video recorder 102 in a play state.

The audio and video signals played back by the video recorder 102 are transmitted to the specific one of the personal computers 103 to 106 by way of the router 101. The specific one of the personal computers 103 to 106 outputs a sound based on the audio signal and displays a picture based on the video signal.

Later on, the specific one of the personal computers 103 to 106 transmits a TEARDOWN request 211 for halting the playback of the audio signal to the router 101 and, in response to the TEARDOWN request 211, the router 101 transmits an OK status signal 212 to the specific one of the personal computers 103 to 106 to indicate that the generation of the data stream of the audio signal will be halted.

By the same token, the specific one of the personal computers 103 to 106 transmits a TEARDOWN request 213 for halting the playback of the video signal to the router 101 and, in response to the TEARDOWN request 213, the router 101 transmits an OK status signal 214 to the specific one of the personal computers 103 to 106.

After transmitting the OK status signals 212 and 214, the CPU 1 employed in the router 101 converts each of the TEARDOWN requests 211 and 213 each serving as an RTSP control command into infrared-ray remote-control data such as an SIRCS command to be output to the LED driver circuit 15. The data drives the LED driver circuit 15 to transmit an infrared-ray remote-control signal from its LED 15a. The infrared-ray remote-control signal puts the video recorder 102 in a halt state.

As described above, in accordance with the embodiment, by virtue of the router 101 having functions to input an analog signal and transmit an infrared-ray remote control signal, a network using existing Ethernet cables and the IP protocol allows audio and video signals generated by an audio/video apparatus having no digital interface to be played back by a personal computer. Thus, for example, a shared video recorder can be controlled by personal computers installed in different rooms. As a result, pictures and sounds can be enjoyed by using any ones of the personal computers.

It should be noted that, when a TEARDOWN command is executed, a route between a client and the server is unavoidably lost. It is thus necessary to execute the sequence of commands starting with a SETUP request in order to play back audio and video signals in any of the personal computers 103 to 106.

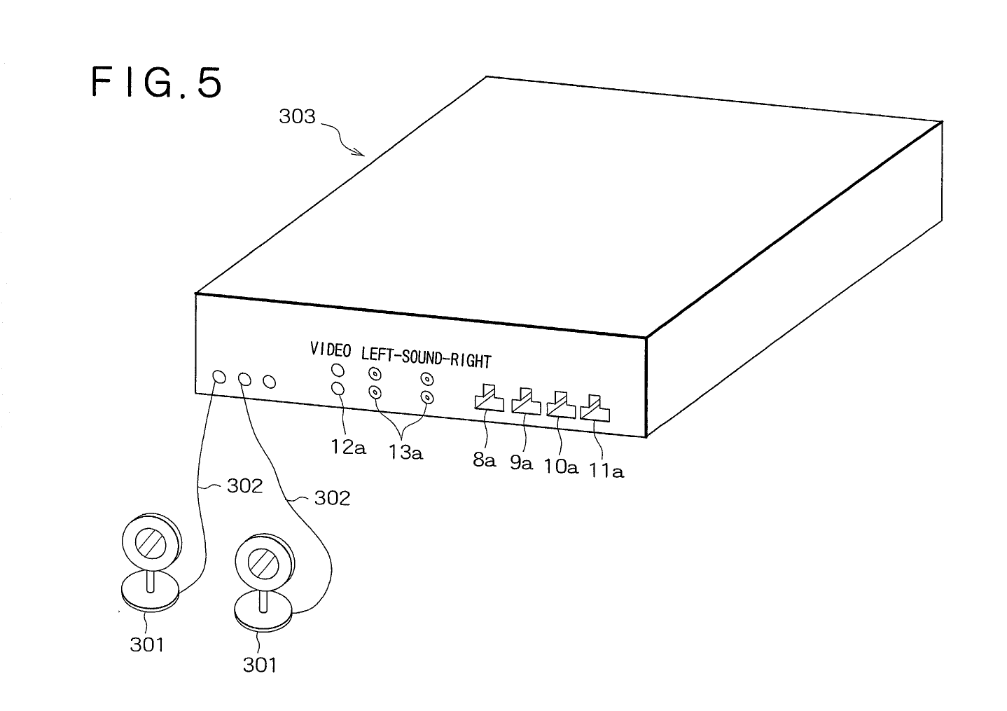

The router 101 shown in FIG. 1 has only one pair of analog audio and video inputs 12a and 13a. It should be noted, however, that more than one pair can also be provided. In this case, a plurality of infrared-ray remote-controllers 301 each including the LED driver circuit 15 and the LED 15a can be connected to the router 101. To put it concretely, the infrared-ray remote controller 301 is modularized and physically separated from the router 303 and connected to the router 303 by a cable 302 as shown in FIG. 5. By installing each of the infrared-ray remote-controllers 301 at a location close to an audio/video apparatus, the infrared-ray remote-controllers 301 can be controlled individually to give a command to the respective audio/video apparatus. In addition, by execution of the RTSP (Real Time Streaming Protocol) control, a plurality of data streams can be distinguished from each other. Thus, it is possible to execute control of selecting an audio/video apparatus connected to the router 303 from a personal computer. It should be noted that the control using the infrared-ray remote controller 301 can also be applied to a router having only a pair of analog audio and video inputs.

In addition, in the embodiment described above, a personal computer controls operations to turn on and off an audio/video apparatus. It should be noted, however, that a personal computer is also capable of controlling the audio/video apparatus's other functions such as a function to read a tape counter indicating information on a time.

Furthermore, in the embodiment described above, personal computers are each connected directly to the router. It is worth noting, however, that the technical scope of the present invention conceptually includes a case in which a computer connected to the router by a modem and a public network controls the audio/video apparatus.

Moreover, in the embodiment described above, an audio/video apparatus serves as the external apparatus. It should be noted, however, that another external apparatus can of course be used as well. Examples of the other external apparatus are another personal computer unconnectable directly to the home network and an air-conditioning apparatus. In the case of an air-conditioning apparatus serving as the external apparatus, analog lines connecting the air-conditioning apparatus to the router are not required. Thus, the router does not require an analog input port and an A/D converter. The scope of the present invention also be applied to a range not including a router that does not have an analog input port and an A/D converter.

As described above, in accordance with the present invention, an analog apparatus can be connected to a network in a simple configuration and, in addition, the analog apparatus can be operated through the network.

While the preferred embodiment of the present invention has been described using specific terms, such description is for illustrative purposes only, and it is to be understood that changes and variations may be made without departing from the spirit or scope of the following claims.

What is claimed is:

1. A router comprising:
routing means for routing an IP packet;
an infrared-ray-emitting unit for emitting an infrared ray to an external apparatus; and
control means for controlling said infrared-ray-emitting unit to emit an infrared ray based on a signal for controlling said external apparatus in accordance with data included in an IP packet received by said routing means.

2. A router according to claim 1, wherein an apparatus exchanging an IP packet with said routing means is a computer.

3. A router according to claim 2, wherein a control protocol adopted between said router and said computer is an RTSP (Real Time Streaming Protocol).

4. A router according to claim 2 or 3, said router further comprising:
an input unit for inputting an analog signal output by said external apparatus; and
conversion means for converting said input analog signal into a digital signal, which is disassembled into IP packets to be output to said computer.

5. A router according to claim 4, wherein said external apparatus is an audio/video apparatus.

6. A router according to any one of claims 1 to 5, wherein said infrared-ray-emitting unit can be mounted on and dismounted from a main body of said router.

7. A router according to any one of claims 1 to 6, said router having a plurality of said infrared-ray-emitting units, which can each be mounted on and dismounted from a main body of said router.

8. A router comprising:
an infrared-ray-emitting device for controlling an external apparatus; and
an analog input port for receiving an analog signal from said external apparatus.

9. A router according to claim 8, wherein said analog input port comprises an audio-signal input sub-port for inputting an analog signal and a video-signal input sub-port for inputting a video signal.

10. A method for controlling an audio/video apparatus by using a router, comprising the steps of:
emitting an infrared ray based on a signal for controlling said audio/video apparatus from said router to said audio/video apparatus in accordance with a request made by a computer connected to said router;
driving said router to convert an analog signal supplied by said audio/video apparatus as a result of execution of an operation at said above step to said router into a digital signal; and
outputting said digital signal obtained as a result of conversion from said router to said computer.
